(19) United States
(12) Patent Application Publication
(10) Pub. No.: US 2015/0283021 A1
(43) Pub. Date: Oct. 8, 2015

(54) Vision Training Device

(71) Applicant: Richard Daly, Naples, FL (US)

(72) Inventor: Richard Daly, Naples, FL (US)

(21) Appl. No.: 14/678,984

(22) Filed: Apr. 4, 2015

Related U.S. Application Data
(60) Provisional application No. 61/975,016, filed on Apr. 4, 2014.

(51) Int. Cl. A61H 5/00; G02B 5/04; G02B 27/00; G02B 27/01

(52) U.S. Cl. CPC A61H 5/005; G02B 27/0172; G02B 5/04; G02B 27/0093

(57) ABSTRACT

This invention employs at least two precision-controlled Risley prisms to create a vision training device that helps patients afflicted with strabismus to overcome muscle imbalances while also helping to effect therapeutic neuro-plasticity to rehabilitate the neurological control system of the eyes including the brain and the extraocular muscles that control eye movement. Various treatment options exist, but the current invention offers additional benefits including letting the patient multitask during therapy, and giving the practitioner a wider selection of training regimens.

### CROSS REFERENCE TO RELATED APPLICATIONS

This application claims priority of U.S. application No. 61/975,016, filed Apr. 4, 2014.

### FIELD OF THE INVENTION

This invention relates to vision therapy, and more particularly, to training the neurological control system of the eyes including the brain and the extraocular muscles that control eye movement individuals suffering from strabismus and related eye conditions so that patients suffering from these conditions can more easily achieve stereopsis.

### BACKGROUND ART

Stabismus, an abnormal alignment of one or both eyes, is characterized by a turning inwards or outwards of the eyes such that both eyes cannot be directed at the same point in space at the same time. The divergence in the alignment of the eyes may also occur to some degree in the vertical axis. Strabismus often causes double vision or suppression of one eye. Double vision and suppression may also result when a phoria is exacerbated by stress or tiredness. A resting phoria is a measure of relative position of the eyes in the absence of fusion. Headaches may sometimes result from phoria differences in the 9 cardinal fields.

Surgery may be performed to help align the eyes by correcting the extraocular muscles that control the eyes, but this is invasive and does not always have the desired result. Prisms can be prescribed to compensate for strabismus and related eye conditions, but do not address the underlying condition.

Therapeutic prisms can be utilized to train patients to compensate for strabismus and related eye conditions. Prisms are alternately place din front of the patent's eyes. This practice is laborious as compared with the present invention.

Tranalglyphs use red-green glasses in conjunction with red and green patterns on cards to treat strabismus and related eye conditions. With tranalglyps, each eye is typically shown the same pattern, but in a different color and on a different card. the cards are moved relative to each other to get the eyes to move into better alignment. Vectograms are similar to tranalglyps, but use light-polarizing cards and glasses instead of red and green technology to isolate what each of the eyes see.

Both tranalglyphs and vectograms require that the patient focus on specialized cards during the therapy. The present invention allows the therapy to take place in free space while the patient performs daily routines such as watching television or reading a book.

### BRIEF SUMMARY OF THE INVENTION

An object of the present invention is to provide therapeutic corrective measure for persons experiencing strabismus and related eye conditions.

The present invention includes the use Risley prisms to increase the patient's ability to overcome or compensate for the muscle imbalances that are associated with strabismus and related eye conditions. The Risley prisms redirect the light coming in to each eye such that the patient's extraocular muscles can compensate in order to achieve binocular fusion.

It is a feature of the present invention that the rotation of the Risley prisms are controlled by a computer program, allowing for smooth, gradula, continuous rotation that will minimize the chance of the patient breaking fusion.

It is another feature of the present invention that the vision training can be carried out in free space while the patent performs daily routines such as watching television or reading a book.

It is yet another feature of the present invention that the Risley prisms placed in front of each eye may be controlled independently, allowing for numerous additional vision training regimens such as allowing one ye to remain stationary while the other tracks or allowing patients to start training from their at-rest position.

### DETAILED DESCRIPTION OF THE INVENTION

This invention relates to a vision training device composed of two or more motorized Risley prisms controlled by a computer and oriented in a housing so that one or more Risley prisms are oriented in front of each eye of the patient. The housing and components being preferably made from plastic or some form of metal, and the prisms being preferably plastic or glass in composition. The individual Risley prisms may use closed loop or sensor feedback. The individual prisms that make up the Risley prisms may also be independently motorized and computer controlled and may also use closed loop or sensor feedback to achieve additional functions. The Risley prisms are composed of two identical prisms that, when rotated 180 degrees in opposite directions, move the image viewed through them from a maximum deviation in one direction through zero deviation to a maximum deviation in the opposite direction. The image seen by each eye is displaced most often along the horizontal axis, but the horizontal alignment may be rotated for one or both Risley prisms to accommodate individuals with vertical disparities or combinations of horizontal and vertical disparities. This could also be accomplished by adding another Risley prism in front of one or both eyes for vertical image displacement.

In one embodiment, the housing for the Risley prisms is mounted on the patient's head. In this embodiment, the housing for the Risley prisms may contain a nose piece and temples as a par of glasses would have.

In another embodiment, the housing for the Risley prisms is mounted to a table or similar surface.

In yet another embodiment, the housing for the Risley prisms is hung from a stand while being used by the patient.

The housing that contains the Risley prisms may be connected to a separate control box via wires or wireless technology. The control box may contain a computer control for the motors and a touch screen display user interface for selecting a training program. Alternatively, the housing may contain an on-board controller.

The user interface for selecting a training program may incorporate a multitude of functionality including but not limited to mode selection, speed selection diopter selection, number of cycles selection, start position selection, a start button, a pause button, a resume button, a stop button, and a run time progress report.

The invention claimed is:

1. A vision training device comprising at least two independently computer controlled Risley prisms so that at least one Risley prism is mounted in front of the right eye and so that at least one Risley prism is mounted in front of the left eye of a subject.

2. The vision training device according to claim 1 further comprising a computer controlled by a touch screen display interface that incorporates a multitude of functions including but not limited to mode selection, speed selection, diopter selection, number of cycles selection, a stop button, and a run time progress report.

3. The vision training device according to claim 2 wherein the starting position can be adjusted so that it compensates for the disparity in the resting strabismus or resting phoria of the eyes at their natural resting gaze.

4. The vision training device according to claim 2 wherein the diopter settings are set so as to very slowly exercise the eyes and the brain without breaking fusion a multitude of times so as to build up fusional reserve in the direction of binocular vision.

5. The vision training device according to claim 2 wherein the Risley prism can be used to improve sport performance by executing a pursuit program that exercises the eyes by moving them back and forth in the same direction.

6. The vision training device according to claim 2 wherein the Risley prism can be used to improve sports performance by executing a program where the eyes jump from one setting to another or jump between a series of settings at a variety of speeds for various numbers of cycles.

7. The vision training device according to claim 2 wherein the Risley prisms can be used to hold fixation of one eye steady while moving the other eye towards the desired final position.

8. The vision training device according to claim 2 wherein the unit can be fitted with eye tracking devices for tracking the movement over time of one or both eyes and may be combined with the movement of the Risley prisms.

9. The vision training device according to claim 2 wherein the individual motors have knobs that can be used to manually adjust the Risley Prisms.

10. The vision training device according to claim 2 wherein the device can be used over multiple training sessions to move the patient closer and closer to their desired goal.

11. The vision training device according to claim 2 wherein the device is head mounted.

12. The vision training device according to claim 2 wherein the device is table mounted.

13. The vision training device according to claim 2 wherein the device is floor mounted.

14. The vision training device according to claim 2 wherein the device may be equipped with a trial lens holder so that a patient's prescription or other lenses could be inserted.

15. The vision training device according to claim 2 wherein the device is wirelessly controlled and powered by batteries to increase mobility of the patient.

16. The vision training device according to claim 2 wherein the device is used in conjunction with various lighting conditions or targets to facilitate training.
